(19) United States
(12) Patent Application Publication
(10) Pub. No.: US 2006/0223469 A1
(43) Pub. Date: Oct. 5, 2006

(54) Radio receiver device having field intensity detector

(75) Inventor: Yoshihisa Shibata, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/390,086

(22) Filed: Mar. 28, 2006

(30) Foreign Application Priority Data
Mar. 30, 2005 (JP) 2005-97696

(51) Int. Cl. H04B 17/00

(52) U.S. Cl. 455/226.1

(57) ABSTRACT

A radio receiver device of the present invention may be used in a navigation system mounted on an automotive vehicle. The radio receiver device includes a receiver for receiving radio waves, a detector for detecting field intensity of the radio waves and a display panel for displaying the detected field intensity together with a name of the radio station and its carrier frequency. The field intensity is classified into several intensity ranks. The intensity ranks are displayed on the display panel by colors or other marks which are easily recognized by a driver. The driver is able to select one station having proper field intensity according to his preference without sacrificing his concentration on driving.

### CROSS-REFERENCE TO RELATED APPLICATION

This application is based upon and claims benefit of priority of Japanese Patent Application No. 2005-97696 filed on Mar. 30, 2005, the content of which is incorporated herein by reference.

### BACKGROUND OF THE INVENTION

1. Field of the Invention

The present invention relates to a ratio receiver device mounted on a moving body such as an automotive vehicle.

2. Description of Related Art

A field intensity of broadcasting waves which are now being received by a radio receiver mounted on a vehicle may become gradually weaker, when the vehicle is moving out from a service area covered by the broadcasting station. In this case, a driver has to switch to another broadcasting station, a field intensity of which is sufficiently high. However, the drive does not know which station satisfies such conditions.

There is a conventional device, in which broadcasting stations having a sufficient field intensity at the present position of the vehicle are automatically chosen, and such broadcasting stations are notified to the driver together with broadcasting programs. The driver may receive such information either through a speaker or through a display on a display panel. The driver selects one station among from such stations by checking all the information notified to him. This means that driver's concentration on driving has to be disturbed, and there is a possibility that an accident may occur.

To cope with this problem, JP-A-10-163890 proposes a radio receiver device, in which another broadcasting station is automatically selected when a vehicle drives out of a service area of one broadcasting station. In this device, however, conditions for selecting a broadcasting station have to be predetermined and stored in a memory. The conditions for selecting a broadcasting station may be such that a station to be selected is predetermined for each area, or that a station having a highest field intensity at the present position of the vehicle is selected.

In the proposed device, however, a broadcast is automatically selected according to predetermined conditions without considering user's preference at that time. Therefore, a broadcast to which the user does not want to listen may be selected. In addition, an additional space in the memory is required to store the conditions for automatic selection.

### SUMMARY OF THE INVENTION

The present invention has been made in view of the above-mentioned problem, and an object of the present invention is to provide an improved radio receiver device, in which a user is able to easily choose another broadcasting station having a sufficient field intensity when a vehicle moves out of a service area of one station.

The radio receiver device of the present invention is advantageously used together with a navigation system mounted on an automotive vehicle. The radio receiver device includes a radio receiver for receiving broadcasting waves such as FM radio waves, a detector for detecting a field intensity of the radio waves, and a display panel for displaying buttons for selecting a broadcasting station. A name of a broadcasting station and its carrier frequency are shown on each selecting button. The field intensity of the broadcasting station is also displayed on the display panel together with the selecting buttons.

The field intensity is displayed in various ways. For example, it may be divided into several ranks (e.g., rank-A to rank-D) according to the intensity levels. Colors are allocated to respective ranks (e.g., green for rank-A, yellow for rank-B, etc.), and the selecting buttons are colored with the color corresponding to the intensity rank. The colored selecting buttons may be displayed in order of the carrier frequency or in order of the intensity rank. Alternatively, the intensity ranks may be displayed by other marks, such as characters, stars or graphs.

When the vehicle drives out of a service area covered by one broadcasting station, some other stations are displayed on the display panel together with marks or symbols indicating the respective field intensities. A driver is able to easily select one station that has proper field intensity and to which he/she wants to listen by simply touching a selecting button. Since the field intensity is clearly indicated, it is quite easy for the driver to select a station having proper field intensity at a present position of the vehicle.

The detected field intensity may be memorized together with a position where the field intensity is detected. When the field intensity detected within a predetermined distance from a present position of the vehicle is memorized, the memorized field intensity can be used as the field intensity at the present position. In this manner, the field intensity can be immediately displayed without waiting for a certain period of time for detection.

According to the present invention, a driver can easily select a broadcasting station that has proper field intensity according to his preference. The driver is able to concentrate on driving without being disturbed by a process of selecting a station. In addition, it is avoided that a new station is automatically selected without considering driver's preference when the vehicle moves out of a service area covered by a formerly selected station. Other objects and features of the present invention will become more readily apparent from a better understanding of the preferred embodiment described below with reference to the following drawings.

### BRIEF DESCRIPTION OF THE DRAWINGS

FIG. 1 is a schematic view showing an automotive vehicle on which a navigation system including a radio receiver is mounted;

FIG. 2 is a block diagram showing a navigation system including a radio receiver;

FIG. 3 is a block diagram showing an example of a radio receiver;

FIG. 4 is a flowchart showing a process for displaying broadcasting stations together with their field intensities according to the present invention;

FIG. 5 is an example of a display showing broadcasting stations in colors that are different according to field intensities;

FIG. 6 is another example of a display showing broadcasting stations in order of field intensities detected;

FIG. 7 is an example of a memory in which field intensities are stored together with positions where they are detected;

FIG. 8 is a flowchart showing a modified process for displaying broadcasting stations;

FIG. 9 is an example of a memory in which service areas and carrier frequencies of broadcasting stations are memorized; and

FIG. 10 is an example of a display showing broadcasting stations together with field intensities in various ways.

### DETAILED DESCRIPTION OF THE PREFERRED EMBODIMENT

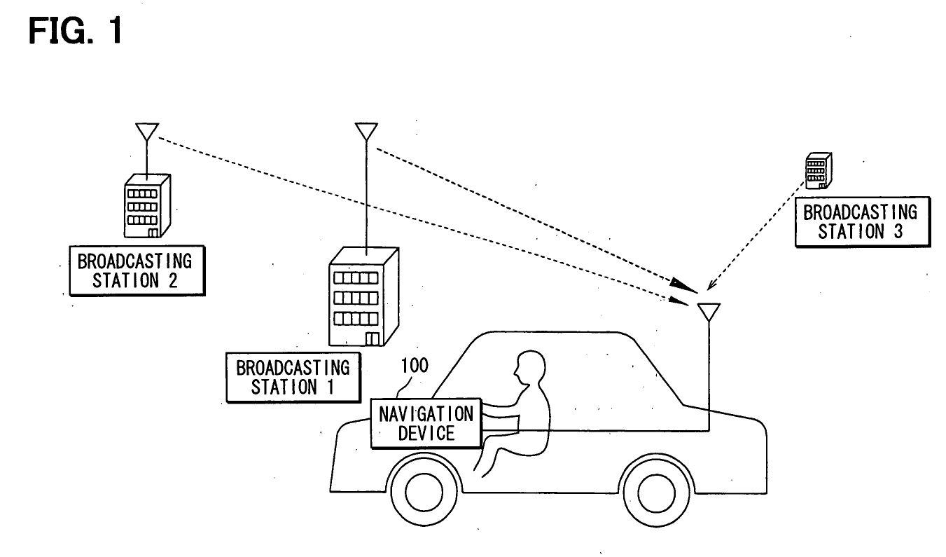

A preferred embodiment of the present invention will be described with reference to accompanying drawings. In this embodiment, a radio receiver device of the present invention is included in a navigation system 100 mounted on an automotive vehicle. As shown in FIG. 1, the radio receiver device included in the navigation system receives radio broadcasts from various stations (broadcasting stations 1-3 are exemplified). The radio receiver may be used alone without being included in the navigation system. Though FM (Frequency Modulated) radio broadcasts are described in this embodiment as an example, other broadcasts such as AM broadcasts or TV broadcasts may replace the FM broadcasts.

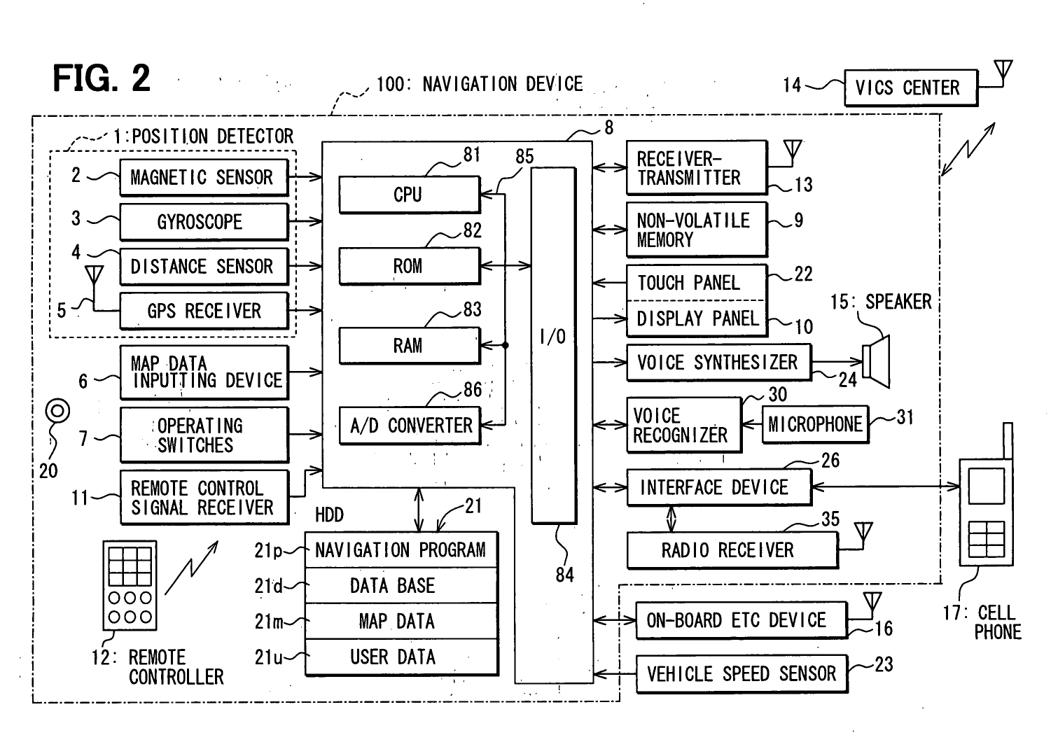

With reference to FIG. 2, the navigation system 100 will be described. The navigation system 100 includes: a position detector 1, a map data inputting device 6, operating switches 7, a remote control signal receiver 11, a voice synthesizer 24, a speaker 15, a non-volatile memory 9, a display panel 10, a hard disc (HDD) 21, a radio receiver 35, a controller 8 and a remote controller 12.

The position detector 1 is a known device including a magnetic sensor 2, a gyroscope 3, a distance sensor 4 and a GPS (Global Positioning System) receiver that receives signals from satellites. Since these components of the position detector 1 have respective errors, they are used in combination to compensate respective errors and to minimize an overall error. Some of these components may be eliminated, or signals from other sensors, such as a steering sensor or a vehicle speed sensor 23, may be used in the position detector 1.

The operating switches 7 may be composed of mechanical switches and touch panels 22 formed integrally with the display panel 10. As the touch panels 22, so-called resistor film type touch panels are widely used. The resistor film type touch panels are composed of a glass substrate and a transparent film, both disposed with a certain space therebetween (a so-called spacer) and including two dimensional wirings (in X and Y directions). When a certain point on the X-Y plane is touched, a resistance at the touched point changes. In this manner, the touched point of an coordinate on the X-Y plane is detected. Alternatively, an infrared type touch panels including an infrared sensor panel and a signal processor circuit may be used as the touch panels 22. In the infrared type touch panels, infrared rays are interrupted by fingers or a pen touching a certain point on the infrared sensor panel. Thus, the coordinate of the touched point on the X-Y plane is detected. Alternatively, an electrostatic capacity type, in which a point where a finger comes closer changes a capacitance, may be used as the touch panels 22.

Inputs to the navigation device may be made through a pointing device such as a mouse or a cursor in addition to the mechanical switches and the touch panels 22. Alternatively, commands may be made by voices through a microphone 31 and a voice recognizer 30. The voice recognizer 30 includes an amplifier, a known DSP voice processor (Digital Signal Processor) that recognizes voices under an algorithm such as a hidden Markov model after converting the voice signals into digital signals, and a memory storing reference data for voice recognition. After the voice signals are converted into numerical data by the DSP, the numerical data are sent to the controller 8. It is possible to input various commands and data through the operating switches 7, the remote controller 12, the microphone 31 and/or the touch panels 22.

The receiver-transmitter 13 is a device for communicating with a VICS (Vehicle Information and Communication System) center, for example. An on-board ETC (Electronic Toll Collection) device 16 communicates with an ETC (Electronic Toll Collection) system to obtain information regarding an amount of a toll to be paid. It is also possible to connect the on-board ETC device 16 to an outside network to communicate with the VICS center 14.

The controller 8 is a usual computer including known components such as CPU 81, ROM 82, RAM 83, A/D (Analog-Digital) converter 86. These components are interconnected through bus lines 85 and connected to an I/O (Input-Output Interface) 84. The CPU 81 is operated under a navigation program 21p and data stored in a hard disc (HDD) 21. The data stored in the HDD 21 are read out, and the data are stored in the HDD 21 under control of the CPU 81. The A/D converter 86 converts analog data fed from outside devices such the position detector 1 into digital data that are able to be handled in the CPU 81.

The HDD 21 includes, in addition to the navigation program 21p, map data 21m including map-matching data for improving accuracy of detected positions and road data showing road connections, various data base 21d, and user data 21u inputted by a user. The map data 21m stores road-network data including link information and node information in addition to map data to be displayed on the display panel 10. The link information is information regarding each link connecting nodes, and the node information is information regarding nodes such as intersections and branching-out points. The link information includes a coordinate of each node, to which it is connected, the number of lanes for turning to right or left at each node, and other links connected to each node.

The user data 21u includes auxiliary information for the route guidance and entertainment to which a user may add additional information. Such additional information may be inputted or renewed through the operating switches 7, the remote controller 12 or the microphone 31. Further, the map data 21m and the user data 21u may be added or renewed through the map data inputting device 6 to which data are fed from a memory medium 20. A CD-ROM or a DVD is generally used as the memory medium 20. It is also possible to use other media such as a memory card when such is suitable.

The non-volatile memory 9 is constituted by an EEPROM (Electrically Erasable and Programmable Read Only Memory) or a rewritable semiconductor memory such as a flash memory. Information and data required for operation of the navigation system 100 are stored in the non-volatile memory 9. The memories stored in the non-volatile memory 9 are not erased when the navigation system 100 is turned off. The information and data required for operation of the navigation system 100 may be stored in the HDD 21 in place of the non-volatile memory 9. Further, one part of such information and data may be stored in the non-volatile memory 9 and another part in the HDD 21. Since an access speed to the non-volatile memory 9 is higher than that to the HDD 21, it is advantageous to store the data that are frequently written and read in the non-volatile memory 9 and other data in the HDD 21. Further, it is possible to store the same data memorized in the non-volatile memory 9 also in the HDD 21 as backup data.

The display panel 10 is a known color display panel such as a dot-matrix LCD (Liquid Crystal Display) including a driver circuit for operating the LCD. An active matrix driving method is employed in the driving circuit. A transistor for turning on or off is used for each pixel on the display panel. Image display is controlled by signals and image data sent from the controller 8. In place of the LCD, an EL (Electro-luminescence) display or a plasma display may be used.

The speaker 15 is connected to the voice synthesizer 24 which is in turn connected to the controller 8 through the I/O 84. Analog voices are synthesized in the voice synthesizer 24 based on digital voice data stored in the non-volatile memory 9 or the hard disc HDD 21 under control of the navigation program 21p. The synthesized analog voices are outputted from the speaker 15. As a method of synthesizing the analog voices, following methods may be used: a record-editing method in which voice waveforms or codified voice waveforms stored in the memory are connected and edited; a parameter-editing method, in which parameters obtained by analyzing voice waveforms are stored in the memory, and voices are synthesized in the synthesizer by combining the parameters; or a rule-synthesizing method in which voices are synthesized from a series of characters or a series of sound elements based on rules of phonetics and linguistics.

The vehicle speed sensor 23 detects a rotational speed of a wheel and feeds the detected signals to the controller 8 that calculates a driving speed of the vehicle based on the rotational speed of the wheel. The controller 8 calculates a period of time required for driving from the present position to a destination, for example. Outside devices such as sensors and other controllers are connected to the controller 8 through an interface device 26. The interface device 26 includes I/O circuits and connectors and performs one or more of the following functions: (1) connection to a device for backing-up memories stored in the non-volatile memory 9 and the HDD 21; (2) connection to an on-board LAN (Local Area Network) for communicating with other on-board devices; and (3) connection to a cell phone 17. It is also possible to input data from the on-board ETC device 16 and the vehicle speed sensor 23 through the interface device 26.

When a user inputs a command for performing route guidance to the navigation system 100 through the operating switches 7, the remote controller 12 or the microphone 31, the following process is carried out in the navigation system 100. A present position is calculated based on signals received from the GPS satellites, and an appropriate driving route from the present position to the destination designated by the user is calculated. The driving route is shown on the display panel 10, overlapped on a road map shown on the same display panel 10. The route guidance is given to the driver (user) by images displayed on the display panel 10 and/or by voices from the speaker 15.

In calculating the driving route from the present position to the destination, Dykestra method (a known method) may be used, for example. In the Dykestra method, a total route evaluation value from the present position to the destination is calculated by summing up the evaluation values for each link and node, based on the data and information regarding the links, nodes and their connections. A driving route that has the lowest total route evaluation value is selected as the most appropriate driving route. Evaluation factors for each link are predetermined based on a length of the road, a kind of the road (a toll road, an expressway, a country road, etc.), a width of the road, the number of lanes, turning regulations at the intersection, presence of traffic signals at the intersection, and so on. For example, a wider road has a lower evaluation factor, and a road having a larger number of lanes has a lower evaluation factor. The evaluation value of each link may be calculated, for example, according to the following formula: (length)×(width factor)×(kind-of-road factor)×(congestion factor). The width factor, the road-kind factor and the congestion factor are set according to the width of the road, the kind of the road and the degree of congestion of the road, respectively.

After the driving route is determined, points of guidance, such as intersections to be turned or landmark buildings, are set. When the vehicle comes to a point, that is located a certain distance before a point of guidance, guiding voices, such as “turn left at the next intersection” are given to the driver from the speaker 15. For example, the certain distance before the point of guidance is set as follows: 700 m, 300 m or 100 m on a usual road; and 2 km, 1 km or 0.5 km on an expressway.

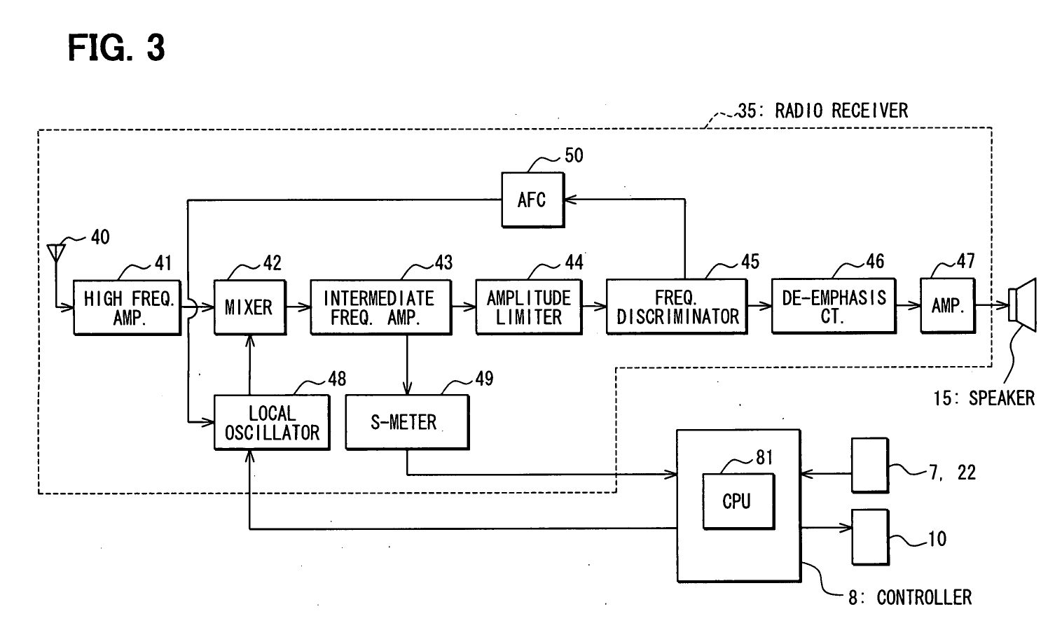

Now, the radio receiver 35 will be described with reference to FIG. 3. An AM radio receiver is shown here as an example. Wireless waves received by an antenna 40 are amplified in a high frequency amplifier 41. The amplified signals and a local frequency output from a local oscillator 48 are mixed in a mixer 42, thereby generating intermediate frequency signals. The frequency of the local frequency output is determined according to a command from the controller 8. When the user inputs a command indicating a radio station to be selected through the operating switches 7, the remote controller 12, the touch panels 22 or the microphone 31, the controller 8 sends a signal indicating a local frequency to be generated to the local oscillator 48. The local frequency is a frequency required for generating the intermediate signals having the predetermined intermediate frequency in the mixer 42. At the same time, the frequency corresponding to the selected radio station is displayed on the display panel 10.

The intermediate frequency signals are amplified in an intermediate frequency amplifier 43 and are fed to an amplitude limiter 44 that limits an amplitude of the intermediate frequency signals to eliminate any possible disturbances included during transmission of the frequency-modulated wireless waves. The output signals from the amplitude limiter 44 are fed to a frequency discriminator 45 that detects frequency changes in the signals and converts the frequency changes into changes in an amplitude. The outputs from the frequency discriminator 45 are fed to a de-emphasis circuit 46 that suppresses high frequency noises which are often emphasized in the frequency discriminator 45. Finally, the outputs from the de-emphasis circuit 46 are amplified in an amplifier 47, and then outputted from the speaker 15.

The outputs of the frequency discriminator 45 are fed back to the local oscillator 48 through an AFC 50 (Automatic Frequency Control) that is a circuit for stably receiving the frequency-modulated signals. The intermediate frequency signals are also fed to an S-meter 49 from the intermediate frequency signal amplifier 43. The S-meter 49 detects a field intensity E of the broadcasting waves in the intermediate frequency signals. In the S-meter 49, the intermediate frequency signals are FM-detected after passing through a low-pass filter in a known method, and an S-meter signal having a voltage level corresponding to the field intensity E is outputted from the S-meter 49.

In the case where AM (Amplitude Modulation) waves are received, the AFC 50 is eliminated, and the amplitude limiter 44, the frequency discriminator 45 and de-emphasis circuit 46 are replaced with a detector circuit for outputting voice signals. Other structures are the same as those of the radio receiver 35 described above. Further, a short wave broadcast or TV broadcast can be handled in a respectively known manner and can be an input to the navigation system 100.

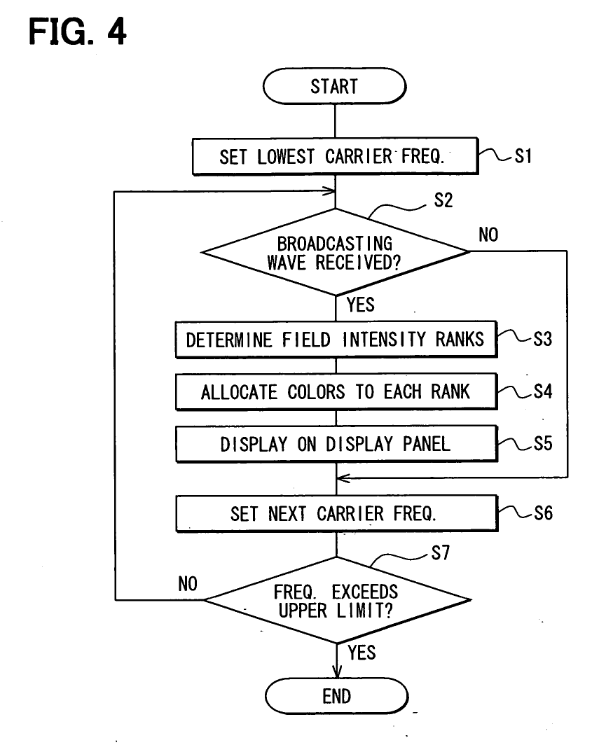

With reference to FIG. 4, a process of displaying broadcasting stations on the display panel 10 together with the field intensities of those stations. A program for performing this process is included in the navigation program 21p. This program may be performed when a user inputs a command for listening to a broadcast through the operating switches 7, the remote controller 12 or the microphone 31. When the radio is turned off, this program may be automatically performed at a predetermined timing, for example, every 30 minutes or every an hour. Alternatively, this program may be performed every time after a certain distance is driven.

At step S1, the radio receiver 35 is set to receive a broadcasting wave having the lowest carrier frequency (in this embodiment, FM broadcasting is exemplified), i.e., 76.0 MHz. At step S2, whether the broadcast of the set frequency is received is checked. If its field intensity E detected by the S-meter 49 is lower than a predetermined level (e.g., 30 dB), it is determined that the broadcast of that frequency is not received, and the process proceeds to step S6 (explained later). If the field intensity E is higher than the predetermined level, it is determined that the broadcast of that carrier frequency is received, and the process proceeds to step S3.

At step S3, ranking is given to the carrier frequency received according to its field intensity E in the following manner, for example:

rank A: 80 dB≦E

rank B: 60 dB≦E<80 dB

rank C: 40 dB≦E<60 dB

rank D: 30 dB≦E<40 dB

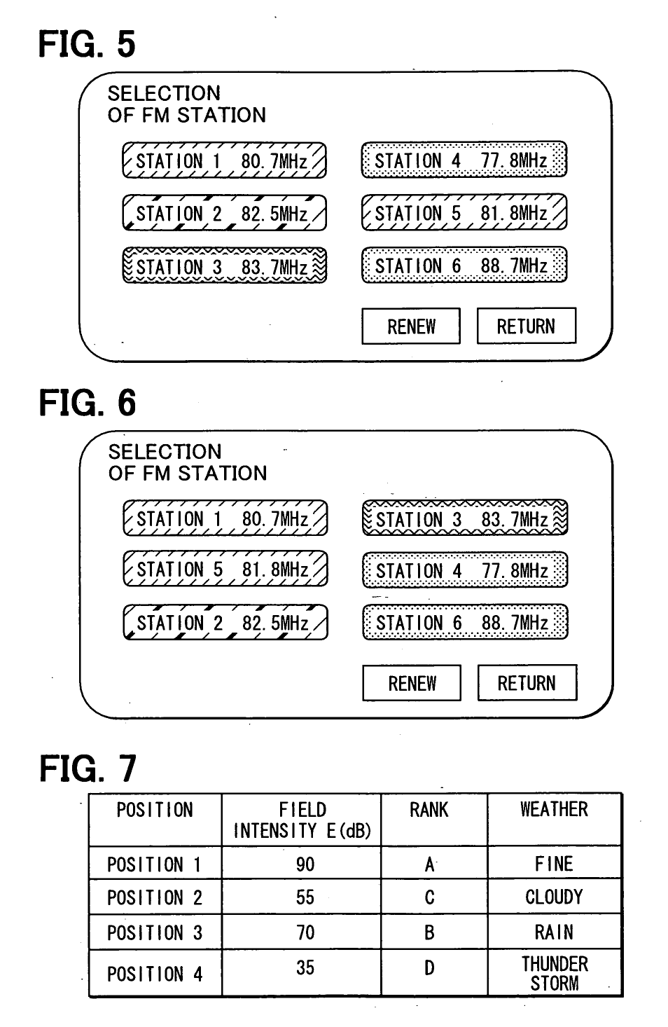

At step S4, a color corresponding to each rank is given, e.g., green for rank A, yellow for rank B, light blue for rank C, and gray for rank D. At step S5, the ranking of the stations is displayed (by colors) on the display panel 10 together with their names and carrier frequencies, as shown in FIG. 5. The names of the broadcasting stations may be stored in the data base 21d in the HDD 21 together with their locations and service areas in the form shown in FIG. 9.

At step S6, the next carrier frequency is set. The carrier frequency next to 76.0 MHz is 76.1 MHz, because the next carrier frequency is calculated by adding a frequency band 100 KHz occupied by an FM radio broadcast to the former carrier frequency 76.0 MHz set at step S1. At step S7, whether the carrier frequency set at step S6 exceeds the highest carrier frequency used in the FM radio broadcast, e.g., 90.0 MHz, is checked. If the carrier frequency set at step S6 exceeds the highest carrier frequency, the process comes to the end. If not, the process returns to step S2 to repeat steps S2-S6.

The field intensities E are detected for all the broadcasting stations included in the carrier frequency range, e.g., 76.0-90.0 MHz, in the process described above. However, the detection of the field intensity E may be limited to the stations having service areas covering a present position of the vehicle. Such selection of the stations may be carried out in reference to the data base 21d storing the data shown in FIG. 9.

An example of a display of the broadcasting stations on the display panel 10 is shown in FIG. 5. In this example, the stations 1-6 are displayed in order of the station number together with carrier frequencies. Station 1 and station 5 having the field intensity in A-rank are shown in green, station 2 in B-rank is shown in yellow, station 3 in C-rank is shown in light blue, and station 4 and station 6 in D-rank are shown in gray. When a user touches one of the buttons showing broadcasting station, the user is able to listen to the broadcast of that station. By touching a “RENEW” button, the field intensity E is detected again and shown.

Another example of the display is shown in FIG. 6. In this example, the broadcasting stations 1-6 are shown in order of the field intensity ranks which correspond to respective colors. The stations are selected in the same manner as in the foregoing example. Yet another example of the display is shown in FIG. 10. In this example, the stations are shown together with the respective carrier frequencies. The field intensity E of each station can be shown in various ways. Some examples are illustrated in FIG. 10. For station 1 and station 2, the field intensity is marked with the ranking (A, B) at the left side of the station name. For station 3 and station 4, the field intensity is shown with star marks. For station 5 and station 6, the field intensity is indicated by bar graphs.

The ranking of the field intensity E may be memorized in the data base 21d in the HDD 21 together with a position where the field intensity is detected, in a form as shown in FIG. 7. In this exemplary memory form, the field intensity E, the ranking (A-D) and weather are listed for each position where the field intensity is detected. The weather may be inputted by the user, or it may be taken from information sent from the VICS center 14.

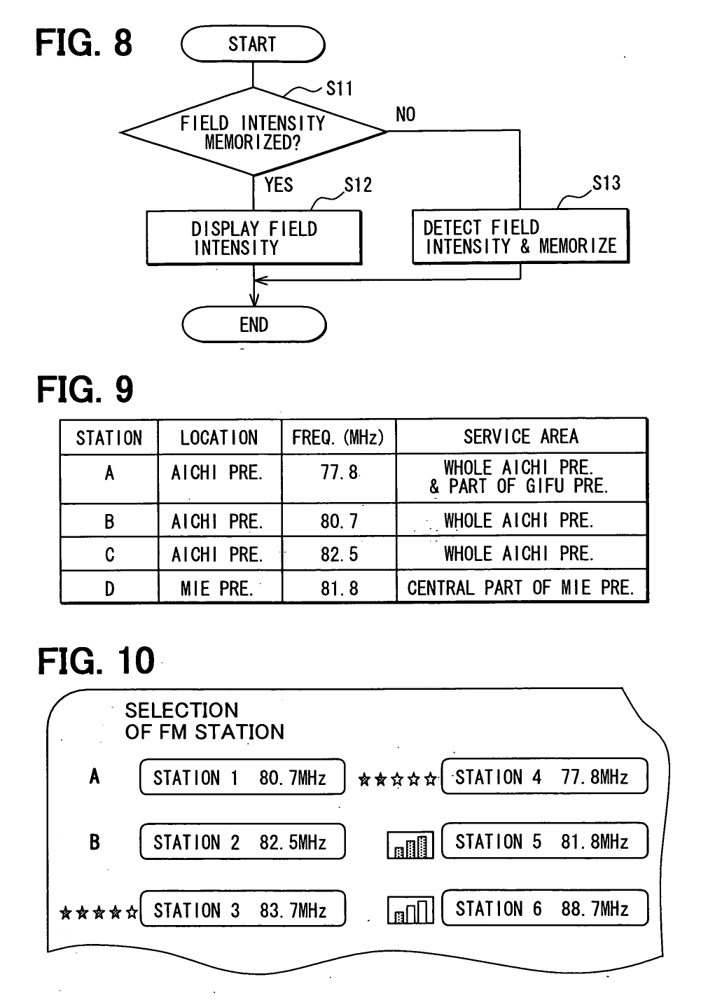

The display of the field intensity may be made based on the field intensity data previously detected and memorized according to a process shown in FIG. 8. At step S11, whether the field intensity at a position within a radius of 200 m (for example) from a present position of the vehicle has been detected previously and memorized in the memory is checked. If the previously detected field intensity is memorized, the process proceeds to step S12, where the memorized field intensity is displayed. In this manner, the field intensity can be immediately displayed without waiting for detection. If the field intensity is not memorized, the process proceeds to step S13, where the field intensity is detected and memorized together with the detected position, the ranking and weather. It is also possible to renew the memorized field intensity by newly detecting it at step S12 even if the previous data are memorized. Alternatively, the memorized field intensity may be renewed according to a user's intention, or it may be renewed only when the memorized intensity was low, e.g., in the C-rank or the D-rank.

According to the present invention, the name of the broadcasting stations and their carrier frequencies are shown on the display panel together with respective field intensities. The field intensity is shown by colors or by other marks which are easily recognized by the driver. Therefore, the driver is able to easily select a broadcasting station which has proper field intensity and he/she wants to listen to. A broadcasting station can be selected by simply pushing a button on the display panel without disturbing his concentration on driving. A broadcasting station is not automatically selected when the vehicle moves out of a service area of a formerly selected station. Instead, a new station is selected according to the driver's preference.

While the present invention has been shown and described with reference to the foregoing preferred embodiment, it will be apparent to those skilled in the art that changes in form and detail may be made therein without departing from the scope of the invention as defined in the appended claims.

What is claimed is:

1. A radio receiver device comprising:
a receiver for receiving broadcasting waves from a broadcasting station;
a detector for detecting a field intensity of the broadcasting waves; and
a display device for displaying buttons for selecting a broadcasting station along with indication of its field intensity level.

2. The radio receiver device as in claim 1, wherein:
the buttons for selecting a broadcasting station are displayed in order of the field intensity.

3. The radio receiver device as in claim 1, wherein:
the buttons for selecting a broadcasting station include carrier frequencies of the respective broadcasting stations, and the buttons are displayed in order of carrier frequency.

4. The radio receiver device as in claim 1, further including a position detector for detecting a present position of the ratio receiver and a memory device for memorizing the field intensity in relation to the present position.

5. The radio receiver device as in claim 4, wherein:
when the field intensity detected at a position within a predetermined distance from the present position is memorized, the memorized field intensity is displayed in place of the field intensity detected at the present position.

6. The radio receiver device as in claim 1, wherein:
the indication of the field intensity is made by colors.
